(19) United States
(12) Patent Application Publication
(10) Pub. No.: US 2003/0196544 A1
(43) Pub. Date: Oct. 23, 2003

(54) Temporary connection and pyrotechnic separation device for two elements, without breakage

(75) Inventor: Patrick Comtesse, Mezieres Sur Seine (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: EADS LAUNCH VEHICLES, Paris Cedex 16 (FR)

(21) Appl. No.: 10/401,735

(22) Filed: Mar. 31, 2003

(30) Foreign Application Priority Data
Apr. 19, 2002 (FR) 02 04927

(51) Int. Cl. B64D 1/04

(52) U.S. Cl. 89/1.14

(57) ABSTRACT

A temporary connection and pyrotechnic separation device (10) normally connects two elements (12, 14). This device comprises a connecting part (18), of which a bottom portion (38) is fixed to one (12) of the elements. Active portions (40) of the connecting part (18) cover a space (20) in which there is pyrotechnic expansion tube (16). The active portions are deformable and comprise hook-shaped ends (50) that fit into a notch (36) formed in the second element (14), so that normally there is a pressure connection between the two elements. The effect of firing is to deform the active parts and consequently break this pressure connection.

### DESCRIPTION

1. Technical Field

The invention relates to a device capable of making a temporary connection between two elements and using a pyrotechnic expansion tube to separate these elements, without the need to break any of the parts.

In particular, this type of device may be used in the aeronautical and space industries to control separation of two structural elements in a very short time, transmitting high forces between these two elements if necessary before the break is made.

2. State of Prior Art

When two elements between which forces are transferred have to be separated irreversibly in a very short time, pyrotechnic separation devices integrated into the junction area between the two elements are frequently used by means of a remote control.

Pyrotechnic separation devices generally comprise a pyrotechnic expansion tube, in other words a deformable leak tight metallic tube inside which there is a detonating fuse. A supple material such as rubber is inserted between the detonating fuse and the tube surrounding it. The tube has an oblong section before firing, for example in the shape of an ellipse or a flattened circle.

When the detonating fuse is fired, the shock wave propagates at very high speed along the tube and deforms the tube, tending to make it circular.

In existing pyrotechnic separation devices, the pyrotechnic expansion tube is used to break one of the two elements along a given break line in order to separate the two elements from each other.

In cases in which the elements to be separated are metallic, it is known how to house the pyrotechnic expansion tube in the bottom of a recess with a U-shaped cross section formed in one of these elements. The other element is then fixed in the entry into this recess, for example by bolts or similar means. When the detonating fuse is fired, the two side branches of the hollowed out element are broken along lines defined by thinner areas. Documents FR-A-2 598 796 and EP-A-0 273 061 illustrate devices of this type.

It is also known how to house the pyrotechnic expansion tube between two facing parts of the metallic elements to be separated, as illustrated in document U.S. Pat. No. 4,137,848, by reducing the thickness of one of the said parts. The two elements are connected to each other by bolts or similar means, on one side of the tube and close to the tube. Firing the detonating fuse breaks the part with a reduced thickness.

Document U.S. Pat. No. 3,362,290 describes a layout very similar to that described in documents FR-A-2 598 796 and EP-A-0 273 061. However, instead of breaking the hollowed out element, in this case firing of the detonating fuse shears the rivets that assemble the two elements together before their separation. Consequently, the rivets are hollow and they have a small diameter.

When the elements to be separated are sandwich type structures, it is proposed to house the pyrotechnic expansion tube in part of these structures that do not have a cellular core. The effect of firing the detonating fuse is then to break the parts of the skin of the structure facing the said tube. Layouts of this type are described in documents FR-A-2 779 223 and FR-A-2 779 224.

Document FR-A-2 779 222 describes a comparable layout, in which the two elements are initially connected to each other by at least one glued connecting part. When firing takes place, expansion of the tube causes the connecting part to become unglued and the two elements to separate.

In summary, all known pyrotechnic separation devices associated with metallic parts separate the said parts by controlling breakage of one of them or shearing of the devices that assemble them. The same is usually true for devices associated with parts made of composite materials.

The only exception is the case of the device described in document FR-A-2 779 222, in which a glued connecting part is unglued instead of one of the two elements being broken. However, this type of device can only be used to connect elements made of composite materials.

### PRESENTATION OF THE INVENTION

The purpose of the invention is to make a pyrotechnic separation device with an innovative design that enables it to separate elements made of arbitrary materials, particularly metallic materials, without causing breakage of any part.

According to the invention, this result is achieved by means of a temporary connection and pyrotechnic separation device, comprising a pyrotechnic expansion tube fitted in a space formed in a connecting area between two elements to be separated, the said space being delimited partly by a connecting part fixed to a first of the said elements, the said connecting part normally forming a pressure connection between the said elements and capable of deforming during use of the pyrotechnic expansion tube to release the said pressure connection, characterized in that the connecting part comprises a bottom portion fixed onto a face of the first element and at least one active portion, the end of which can hold a heel of the second element bearing on a complementary impression formed on the first element, to form the said pressure connection, the said space being formed in the first element or in the heel of the second element and opening up onto the face of the active portion of the connecting part between the bottom portion and the end.

With this layout, the two elements can be separated without any part being broken. This eliminates the risk of a fragment released when breakage occurs from damaging equipment close to the junction area.

Advantageously, the above mentioned end of the active portion of the connection part is hook shaped, so that it will normally fit in a notch formed in the heel of the second element.

In this case, the connecting part and the above mentioned face of the first element preferably cooperate with each other through complementary surfaces acting like a wedge, capable of moving the said hook shaped end slightly towards the bottom portion, when the means provided for fastening the said bottom portion onto the base of the first element are tightened.

In the preferred embodiment of the invention, the connecting part advantageously comprises several active portions fixed together with the bottom portion and capable of deforming as they are moved away from the said face, during use of the pyrotechnic expansion tube.

Depending on the case, the two elements may be annular and placed end to end or formed of panels placed end to end. In the first case, the connecting part surrounds the junction area. In the second case, the connecting part overlaps the junction area.

### BRIEF DESCRIPTION OF THE DRAWINGS

We will now describe a preferred embodiment of the invention as an illustrative example that is in no way limitative, with reference to the appended drawings, wherein:

FIG. 1 is a cross sectional view of a device according to the invention before the two elements are assembled,

FIG. 2 is a view comparable to FIG. 1 that shows the assembled device, and

FIG. 3 is a view comparable to FIGS. 1 and 2 that shows the device after use of the pyrotechnic expansion tube.

### DETAILED DESCRIPTION OF A PREFERRED EMBODIMENT OF THE INVENTION

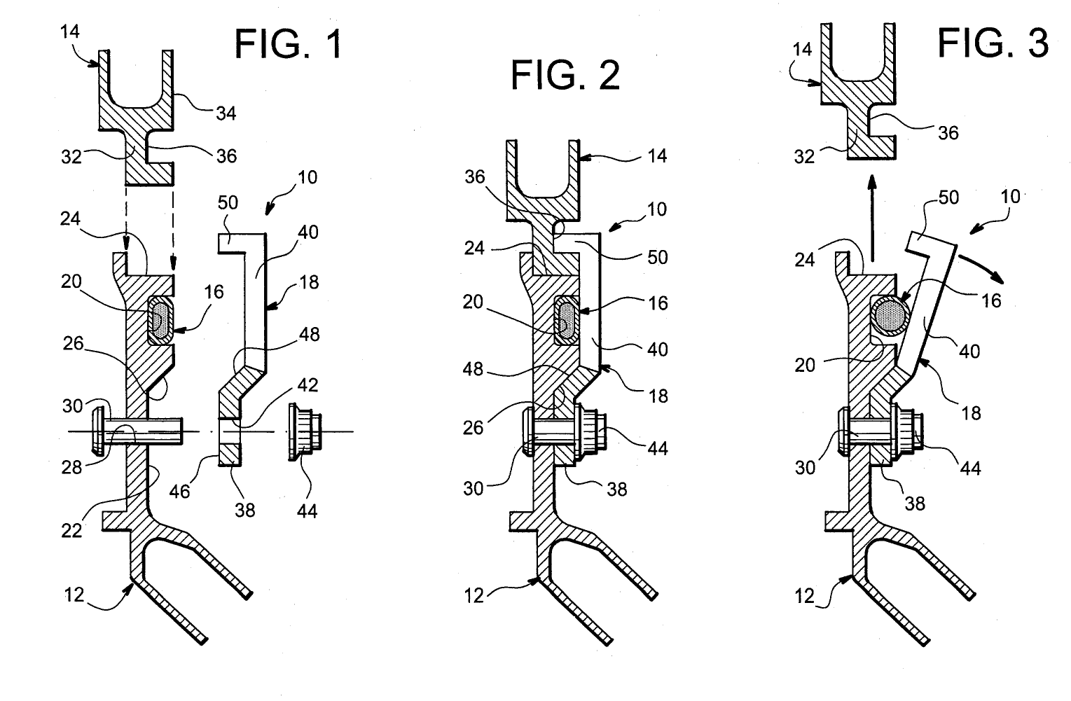

FIGS. 1 to 3 show a preferred embodiment of a temporary connection and pyrotechnic separation device 10 placed between a first element 12 and a second element 14.

The first element 12 and the second element 14 are advantageously formed like two annular elements with approximately the same diameter, or by two panels with an arbitrary shape. In both cases, elements 12 to 14 are designed to be assembled end to end.

The device 10 according to the invention is located in the connecting area between the two elements 12 and 14. It comprises mainly a pyrotechnic expansion tube 16 with a conventional design and a connecting part 18.

As can be seen in FIG. 1 that shows the parts before assembly, the pyrotechnic expansion tube 16 is housed in a space 20 formed in the first element 12 and opens up onto a face 22 of this element. More precisely, the space 20 is materialized by a groove with a rectangular cross section and the pyrotechnic expansion tube 16 is flush with the face 22 of the first element 12 when it is located inside the said groove.

At its end beyond the space 20, the first element 12 comprises an impression 24, the function of which will become clear after reading the following description. This impression 24 is delimited in this case by a side perpendicular to the face 22 of the first element 12 and opening up onto the first face, and by a side parallel to the face 22.

At the side opposite the impression 24 from the space 20, the face 22 of the first element 12 comprises a hollow part connected through an inclined surface 26 to the portion of the said face in which the space 20 is formed.

Holes 28 pass through this hollowed out portion of the face 22 of the first element 12 close to this inclined surface 26, and attachment devices such as screws 30 associated with nuts 44 pass through these holes materializing means for attachment of the connecting part 18 onto the face 22 of the first element 12.

The second element 14 comprises a heel 32 at the end at which it will be assembled to the first element 12. This heel 32 is designed to bear in contact with the impression 24 formed at the end of the first element 12. To achieve this, it is provided with surfaces complementary to the surfaces delimiting the impression 24.

The heel 32 of the second element 14 is also provided with a notch 36 on its face 34 that will be on the same side as the face 22 of the first element 12. In this case, the notch 36 is in the form of a groove with a rectangular cross section.

The connecting part 18 comprises a base portion 38 and at least one or preferably several active portions 40. The active portions 40 and the bottom portion 38 are made as a single piece. They are designed to be able to deform when the force generated by firing the detonating fuse inside the pyrotechnic expansion tube 16 is applied to them.

The bottom portion 38 is designed to be fixed on the face 22 of the first element 12 by the above mentioned attachment means. Consequently, holes 42 pass through the bottom portion, approximately in line with the holes 28 when the connecting part 18 is put into place. The screws 30 are then inserted in the holes 28 and 42 that are in line with each other. The nuts 44 are then screwed onto the screws 30 to complete the attachment means.

The face 46 of the connecting part 18 designed to be applied on the face 22 of the first element 12 has a shape complementary to the shape of the said face 22. Thus, this face 26 of the connecting part 18 comprises an inclined surface 48 complementary to the inclined surface 26 of the face 22.

The inclined surfaces 26 and 48 thus form complementary surfaces acting as wedges, which are arranged such that the connecting part 18 is moved slightly downwards looking at the figures, when the bolts formed by the screws 30 and the nuts 44 are tightened, the said bolts materializing the means for attachment of the connecting part 18 onto the first element 12.

The active portions 40 prolong the bottom portion 38 of the connecting part 18 so as to extend beyond the impression 24 formed at the end of the first element 12, when the connecting part 18 is fixed onto this element.

Each of the active portions 40 comprises a hook shaped end 50. When the connecting part is fixed on the first element 12 and when the heel 32 of the second element 14 is bearing in contact with the impression 24 of the first element 12, the hook shaped end 50 fits into the notch 36 formed in the heel 32 as shown in FIG. 2.

More precisely, the effect of cooperation between the complementary wedge shaped surfaces 26, 48 when the bolts 30, 44 are tightened, is to slightly move each folded hook shaped end 50 towards the said bolts. The inside face of the ends 50 thus bears in contact with the edge of the notch 36 close to the end of the heel 32. This has the effect of pressing the heel 32 in contact with the impression 24 so as to form a pressure connection between the first element 12 and the second element 14.

This layout is obtained after assembly of elements 12 and 14 by connecting parts 18 and attachment means 30, 44, and is shown in FIG. 2. It creates a temporary connection between the different parts and forms a “normal” state of the assembly.

When an order is given to separate the elements 12 and 14, the detonating fuse contained in the pyrotechnic expansion tube 16 is fired. Conventionally, this causes inflation of the tube 16, under the effect of gases released by firing. The initially flat section of the pyrotechnic expansion tube 16 then becomes pseudo circular as illustrated in FIG. 3.

According to the invention, the effect of inflation of the pyrotechnic expansion tube 16 is to fold the active portions 14 of the connecting part 18 about their connection areas with the bottom portion 38 of this part, by moving the first element 12 further away. This is made possible by the rigid nature of the portion of the element 12 in which the space 20 is machined and by the deformable nature of the active portions 40.

The active portions 40 of the connecting part 18 then open in a very short time, like the petals of a flower. This has the effect of completely disengaging the hook shaped ends 50 of the notch 36 formed in the heel 32. The mechanical connection between the elements 12 and 14 is thus eliminated. Therefore these elements can separate from each other as shown in FIG. 3.

Obviously, the invention is not limited to the embodiment described above as an example. Thus, as already mentioned, elements 12 and 14 can be in annular form, or can be composed of plane panels or any other shape of panels. In the first case, the connecting part 18 surrounds the connecting area between the two elements and the active portions 40 are distributed around the entire circumference. In the second case, the connecting part 18 overlaps the junction area between the two panels. Furthermore, attachment means may be in different forms (rivets, screws, etc.). Finally, instead of being housed in a space machined in the first element 12, the pyrotechnic expansion tube 16 may also be fitted in a space machined in the heel 32 of the second part 14, between the end of the heel and the notch 36.

1. Temporary connection and pyrotechnic separation device, comprising a pyrotechnic expansion tube (16) fitted in a space (20) formed in a connecting area between two elements (12, 14) to be separated, the said space (20) being delimited partly by a connecting part (18) fixed to a first (12) of the said elements, the said connecting part (18) normally forming a pressure connection between the said elements and capable of deforming during use of the pyrotechnic expansion tube (16) to release the said pressure connection, characterized in that the connecting part (18) comprises a bottom portion (38) fixed onto a face (22) of the first element (12) and at least one active portion (40), the end (50) of which can hold a heel of the second element (14) bearing on a complementary impression (24) formed on the first element (12), to form the said pressure connection, the said space (20) being formed in the first element (12) or in the heel (32) of the second element (14) and opening up onto the face of the active portion (40) of the connecting part (18) between the bottom portion (38) and the end (50).

2. Device according to claim 1, in which the said end (50) of the active portion (40) of the connecting part (18) is hook shaped, so that it normally fits into a notch (36) formed in the heel (32) of the second element (14).

3. Device according to claim 2, in which the connecting part (18) and the said face (22) of the first element (12) cooperate with each other through complementary surfaces (26, 48) with a wedge effect capable of slightly moving the said hooked shape end (50) towards the bottom portion (38) when the attachment means (30, 44) of the said bottom portion are tightened on the bottom (22) of the first element (12).

4. Device according to claim 3, in which the attachments means are bolts (30, 44).

5. Device according to any one of claims 1 to 4, in which the connecting part (18) is provided with several active portions (40) made in a single piece with the bottom part (38), and capable of deforming by moving away from the said face (22) when the pyrotechnic expansion tube (16) is used.

6. Device according to any one of the previous claims, in which the two elements (12, 14) are annular and are placed end to end, and the connecting part (18) surrounds their junction area.

7. Device according to any one of claims 1 to 5, in which the two elements (12, 14) are panels placed end to end and the connecting part (18) overlaps their junction area.
